(19) United States
(12) Patent Application Publication
(10) Pub. No.: US 2016/0158646 A1
(43) Pub. Date: Jun. 9, 2016

(54) Method, Apparatus, System and Computer Program Product for Event Triggered Games

(71) Applicant: Riku SUOMELA, Tampere (FI)

(72) Inventor: Riku SUOMELA, Tampere (FI)

(73) Assignee: VRINGO INFRASTRUCTURE INC.

(21) Appl. No.: 15/040,820

(22) Filed: Feb. 10, 2016

Related U.S. Application Data
(63) Continuation of application No. 13/616,716, filed on Sep. 14, 2012.
Application No. 13/616,716 is a continuation of application No. 11/393,588, filed on Mar. 30, 2006.

(51) Int. Cl. A63F 13/35; A63F 13/44; A63F 13/792

(52) U.S. Cl. CPC A63F 13/35; A63F 13/792; A63F 13/44

(57) ABSTRACT

A method of providing event triggered games includes operations of receiving a subscription to a game service from a subscriber, providing game content including a game to the subscriber, and enabling remote execution of the game responsive to receipt of a trigger associated with an occurrence of a predefined event of interest.

### RELATED APPLICATIONS

This application is a continuation of U.S. patent application Ser. No. 13/616,716 which was filed with the U.S. Patent and Trademark Office on Sep. 14, 2012 which is a continuation of U.S. patent application Ser. No. 11/393,588 which was filed with the U.S. Patent and Trademark Office on Mar. 30, 2006.

### FIELD OF THE INVENTION

Embodiments of the present invention relate generally to gaming technology and, more particularly, relate to a method, apparatus, system and computer program product for providing event triggered games.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Concurrent with the technological expansion of networking technologies has been a consumer demand for improved wireless network based services. For example, web browsing and other web based services, short message services, email and many services capable of deployment at a mobile terminal are continuously being developed. One area in which there is a demand to provide improved mobile terminal service relates to micro and mini-games. Such games have been popular with users of mobile terminals, such as mobile telephones, due to the ability of such games to provide the users with mobile entertainment. Accordingly, many such games continue to be developed. Micro-games are typically games that last only a few seconds, while mini-games last longer, although still a relatively short period of time.

In current applications, a user of a mobile terminal who wishes to play a micro or mini-game at the user's mobile terminal may launch an application on the mobile terminal to execute the game. Typically, the game is stored in a memory of the mobile terminal although the game may also be played, for example, through a connection to a server hosting the game. Often the game will have been downloaded by the user, although the game may have been installed on the mobile terminal during manufacture. Although such games may be purchased or selected for download in order to provide entertainment, the scope of the user's participation in most games is limited to the game itself. In other words, the user is often engaged in a private diversion. However, it may be desirable to provide a mechanism by which a game player's experience is tied to real world events. Thus, the game player's enjoyment of both the real world event and the game may be enhanced.

### SUMMARY OF THE INVENTION

A method, apparatus, system and computer program product are therefore provided that enables a user of a mobile terminal to receive and participate in mini or micro-games that are event triggered. Thus, for example, a micro or mini-game may be associated with a particular event and execution of the micro or mini-game may be triggered remotely upon occurrence of the particular event. Furthermore, multiple users of a same event triggered micro or mine-game may compete in contests based on a comparison of performance data of each of the multiple users.

In one exemplary embodiment, a method of providing event triggered games is provided. The method includes operations of receiving a subscription to a game service from a subscriber, providing game content including a game to the subscriber, and enabling remote execution of the game responsive to receipt of a trigger associated with an occurrence of a predefined event of interest.

In another exemplary embodiment, a computer program product for providing event triggered games is provided. The computer program product includes at least one computer-readable storage medium having computer-readable program code portions stored therein. The computer-readable program code portions include a first, second and third executable portion. The first executable portion is for receiving a subscription to a game service from a subscriber. The second executable portion is for providing game content including a game to the subscriber. The third executable portion is for enabling remote execution of the game responsive to receipt of a trigger associated with an occurrence of a predefined event of interest.

In another exemplary embodiment, an apparatus for providing event triggered games is provided. The apparatus includes a processing module and a trigger module. The processing module is capable of receiving a subscription to a game service from the mobile terminal and directing provision of game content including a game to the mobile terminal. The trigger module is capable of enabling remote execution of the game responsive to receipt of a trigger associated with an occurrence of a predefined event of interest.

In another exemplary embodiment, a mobile terminal for providing event triggered games is provided. The mobile terminal includes an execution module. The execution module is capable of sending a subscription to a game service to a game server, receiving game content including a game from the game server, and executing the game in response to receipt of a remotely transmitted trigger. The trigger is transmitted responsive to an occurrence of a predefined event of interest.

In another exemplary embodiment, a system for providing event triggered games is provided. The system includes a mobile terminal and a game server. The mobile terminal includes an execution module. The execution module is capable of sending a subscription to a game service to a game server, receiving game content including a game from the game server, and executing the game in response to receipt of a remotely transmitted trigger. The trigger is transmitted by the game server responsive to an occurrence of a predefined event of interest.

### BRIEF DESCRIPTION OF THE DRAWINGS

In the drawings:

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of a system for providing event triggered games at a mobile terminal according to an exemplary embodiment of the present invention;

FIG. 4 illustrates a control flow diagram according to an exemplary method of providing event triggered games at a mobile terminal; and

FIG. 5 is a block diagram according to an exemplary method of providing event triggered games at a mobile terminal according to an exemplary embodiment of the present invention.

### DETAILED DESCRIPTION OF THE PRESENTLY PREFERRED EMBODIMENTS

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

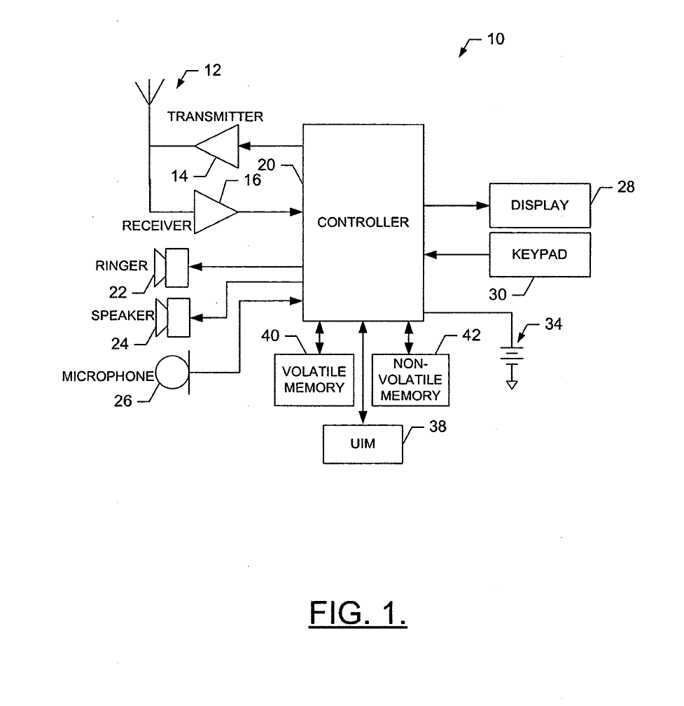

FIG. 1 illustrates a block diagram of a mobile terminal 10 that would benefit from the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, mobile televisions, laptop computers and other types of voice and text communications systems, can readily employ the present invention. Furthermore, mobile gaming devices such as those sold under the trademark Playstation Portable (PSP) and Nintendo DS, for example, may also employ embodiments of the present invention.

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 22, a ringer 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 includes the conventional numeric (0-9) and related keys (#, *), and other keys used for operating the mobile terminal 10. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

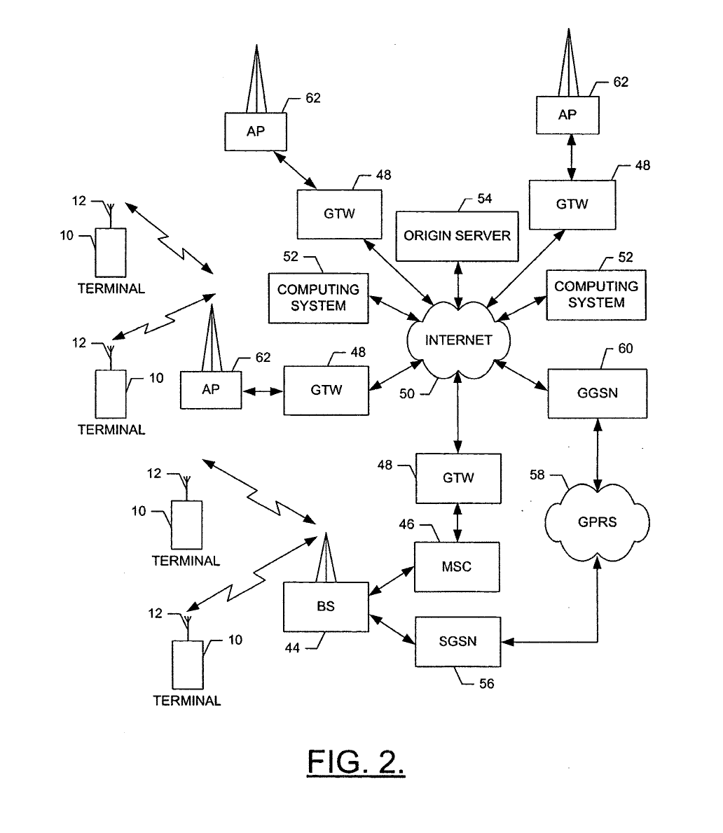

Referring now to FIG. 2, an illustration of one type of system that would benefit from the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

Although the term game will be referred to hereinafter, it should be understood that such term is meant to encompass micro or mini-games which are well known, and any other recreational and interactive activity capable of execution by the mobile terminal 10 such as, for example, a riddle, puzzle, trivia question, test of skill, etc.

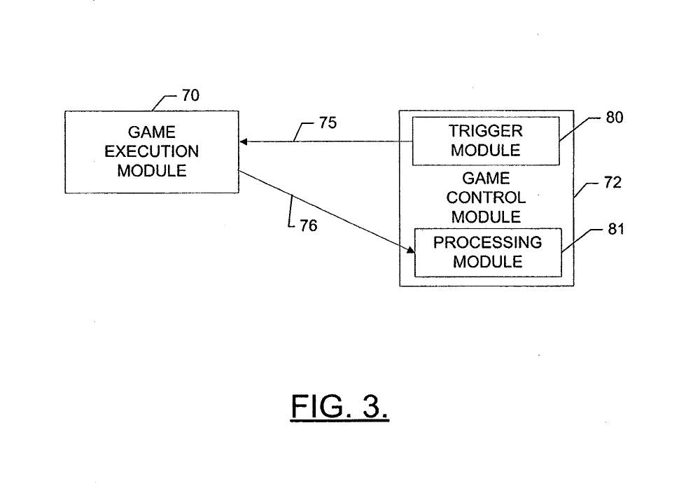

An exemplary embodiment of the present invention will now be described with reference to FIG. 3, in which certain elements of a system for providing event triggered games at a mobile terminal are displayed. The system of FIG. 3 may be employed, for example, on the mobile terminal 10 of FIG. 1 and the computing system 52 or the origin server 54 of FIG. 2. However, it should be noted that the system of FIG. 3, may also be employed on a variety of other devices, both mobile and fixed, and therefore, the present invention should not be limited to application on devices such as the mobile terminal 10 of FIG. 1. It should also be noted, however, that while FIG. 3 illustrates one example of a configuration of a system for providing event triggered games, numerous other configurations may also be used to implement the present invention.

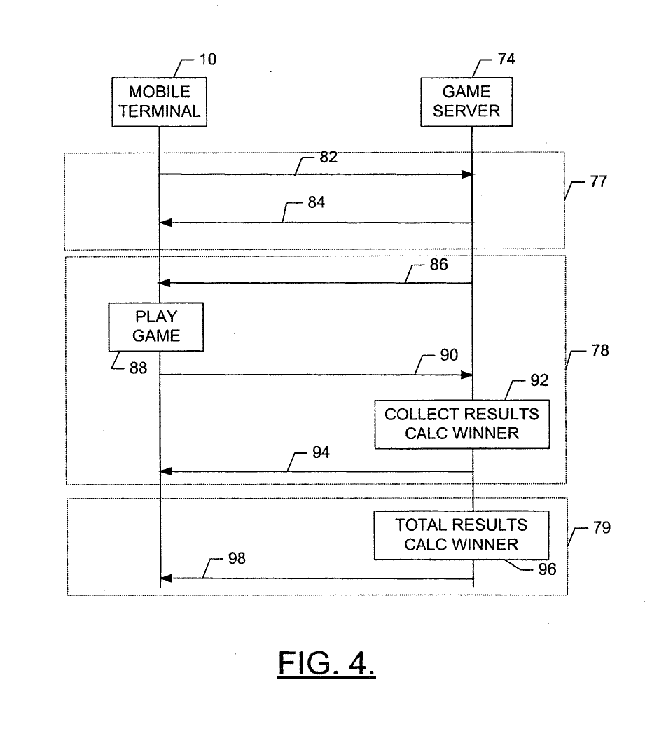

Referring now to FIG. 3, a system for providing event triggered games at a mobile terminal is provided. The system includes at least one game execution module 70 and a game control module 72. The game execution module 70 may be any means or device embodied in hardware, software or a combination of hardware and software that is capable of storing instructions for executing a game in response to a trigger from the game control module 72 and thereafter transmitting the results of the game to the game control module 72. In an exemplary embodiment, the game execution module 70 is software stored at a mobile terminal 10. The game control module 72 may be any means or device embodied in hardware, software or a combination of hardware and software that is capable of storing instructions for remotely triggering execution of a game at a plurality of execution modules responsive to manual or automatic notification of the occurrence of an event of interest and thereafter receiving and processing results of the game from the game execution module or modules. The game control module 72 may include separate modules for triggering execution of the game and processing the results. For example, the game control module 72 may include a trigger module 80 and a processing module 81. In an exemplary embodiment, the game control module 72 is embodied in software as instructions that are stored on a network server called a game server 74 (see FIG. 4). The system of FIG. 3 is a client-server architecture. As such, the game execution module 70 is a game client and the game control module 72 is a server. In an exemplary embodiment, the game server 74 is hosted by an organizer or organizers of a real world event, such as a sporting event or other live performance.

An exemplary embodiment of the present invention may be practiced in response to a mobile terminal user obtaining a subscription to a game service. The subscription may be, for example, for one event, for a given number of events, for a given time period, for a season, etc. Following subscription of a user of the game execution module 70 to a game service that provides event triggered games, the game execution module 70 may receive a trigger 75 from the trigger module 80 of the game control module 72. In an exemplary embodiment, the trigger 75 is wirelessly transmitted to the game execution module 70 via any suitable wireless protocol. The trigger 75 may be embodied, for example, as a short message service (SMS) message indicating a start of the game, or the trigger 75 may cause an application to launch and execute the game if, for example, the game execution module 70 has established a wireless connection to the game control module 72. Upon receipt of the trigger 75, the game execution module 70 launches the game and the mobile terminal user plays the game. Game play typically involves display of visual and/or audio stimuli at the mobile terminal and user interaction via the input interface. Game results 76 are then transmitted to the processing module 81 of the game control module 72 for further processing as described below. It should be noted that although FIG. 3 only shows one game execution module 70, the game control module 72 is capable of simultaneous communication with a plurality of game execution modules.

The trigger 75 may be transmitted in response to a random occurrence of a predefined event of interest associated with a particular real world event such as a sporting event. For example, the trigger 75 may be transmitted in response to a slam dunk at a basketball game, a touchdown in a football game, a homerun in a baseball game, a goal in hockey or soccer, etc. Furthermore, the trigger 75 may be one of multiple possible triggers, in which each trigger is associated with a particular game and each trigger is transmitted in response to the occurrence of a particular event having a predefined association with the particular game. For example, a three point competition game may be triggered in response to a successful three point shot by the home basketball team, while a bricklaying competition may be triggered when the opponent misses an easy basket. The trigger 75 may be transmitted by the trigger module 80 in response to a manual prompt, i.e., an operator may manually instruct the trigger module 80 to send a trigger 75. The manual prompt may be executed in response to any particular event of interest such as the end of a period, a score, fast break, etc. Alternatively, the trigger 75 may be transmitted by the trigger module 80 in response to an automatically generated prompt. For example, statistics normally kept during a sporting event may be tied to appropriate triggers. In other words, the trigger module 80 may be in communication with a statistical database and, responsive to the real-time statistical entries, transmit appropriate triggers associated with events indicated by the real-time statistical entries. It should be understood that any suitable method of causing the trigger 75 to be transmitted in response to an event or occurrence related to the real world event with which the subscription is associated is contemplated.

FIG. 4 illustrates a control flow diagram according to an exemplary method of providing event triggered games at a mobile terminal. In FIG. 4, the mobile terminal 10 is assumed to include an exemplary game execution module 70 and the game server 74 is assumed to include an exemplary game control module 72. As shown in FIG. 4, the method of providing event triggered games at the mobile terminal 10 may be considered to include three states or phases related to provision of a game service. First, during a pre-game phase 77, conditions that enable game play are met. In other words, the pre-game phase 77 is a set up state of the method, in which mobile terminal users may subscribe to the game service. Next, during an in-game phase 78, event triggered games are played by players who subscribed to the game service. The in-game phase 78 may include one or multiple occurrences of either different games or the same game being played in response to event related triggers. Finally, during an optional post game phase 79, results from games played during the in-game phase 78 may be tallied to determine an overall winner from among the players.

The pre-game phase 77 may be considered a set-up phase in which game software is downloaded and installed on the mobile terminal 10. For example, a MIDP2 application jar packet, or other game related content associated with an already installed application (such as a MIDP2 application) may be downloaded during the pre-game phase 77. The pre-game phase 77 of an exemplary embodiment may include a subscription 82 to the game service which may be embodied as a message sent from the mobile terminal 10 to the game server 74. The subscription 82 may also be accomplished either before (i.e., when purchasing a ticket) or during the real world event (however, subscribing during the real world event may hamper the subscriber's ability to win an overall competition due to possible missed games). The subscription 82 may be accomplished by any suitable means, such as by calling a particular telephone number associated with the game service. The particular telephone number could be, for example, posted on a billboard at a sporting event, or on a ticket stub. The subscription 82 may also be embodied as an SMS message from the mobile terminal 10 to the game server 74. In an exemplary embodiment, the subscription 82 may be made in response to an invitation from the game server 74, such as by an SMS message inviting a user of the mobile terminal 10 to subscribe. As another alternative, the subscription 82 may be accomplished by the user of the mobile phone selecting a subscription to the game service at a web page associated with the game service. As yet another alternative, the subscription 82 may be accomplished by a radio frequency identification (RFID) tag and an associated reader. Following the subscription 82, game content is downloaded to the mobile terminal 10 via content data 84. The content data 84 may be stored in the memory of the mobile terminal 10 waiting for execution responsive to receipt of an event related trigger. The content data 84 may include one or more games, which are executable responsive to a particular event related trigger.

The in-game phase 78 of an exemplary embodiment may include an event trigger message 86, which includes a trigger 75 as described above. Typically, organizers of the real world event (i.e., sporting event or other performance) may predefine which occurrences or events will trigger the event trigger message 86. Additionally, the organizers may configure the game server 74 for automatic or manual transmission of the event trigger message 86. Moreover, the organizers may define particular triggers to be associated with particular triggering events. Upon receipt of the event trigger message 86, the mobile terminal 10 executes a game that has been predefined to be associated with the trigger 75 included in the event trigger message 86. In an exemplary embodiment, the event trigger message 86 may include additional game content. For example, the additional game content may include a modification to an existing game, or a completely new game to be played when an associated trigger is received. In other words, the event trigger message 86 may reconfigure one or more of the games. At operation 88, the user of the mobile terminal 10 plays the game that was triggered by the event trigger message 86. Upon completion of the game, the mobile terminal 10 sends game results 90 to the game server 74. The game server 74 collects game results from each subscriber and processes the game results at operation 92. A notification message 94 may then be sent to each subscriber to inform each subscriber of a winner of the game. Alternatively, the notification message 94 may inform each subscriber of top performers and their corresponding times or scores. As yet another alternative, the notification message 94 may inform each subscriber of their score or time relative to the winner or the top performers. Additionally, the notification message 94 may inform each subscriber what the winner or the top performers have won for their achievement. Sponsorship or other advertisement information may also be included in the notification message 94. The in-game phase 78 may include a plurality of sequences of the above-described operations (i.e., trigger game, play game, send results, determine winner, notify players).

The post game phase 79 of an exemplary embodiment includes calculating total results for all games played during the real world event at operation 96. In other words, each subscriber's scores for each of the games are tallied and an overall winner, or overall top performers are determined. In an exemplary embodiment, if multiple games of different types were played during the real world event, then the winner or top performers of each of the different types of games may be determined. Alternatively, for example, if the game service included a subscription option lasting over an entire sports season, or if results from all games over the entire sports season are considered, a season winner or top performer list may be determined. Winners or top performers in a total game or seasonal competition may be announced via a total game or seasonal notification message 98 that is similar to the notification message above.

It should be noted that although the forgoing description describes embodiments of the present invention in terms of phases or states, such phases may be arbitrarily defined and it is rather the operations performed in each of the phases that define embodiments of the present invention and not the arbitrarily chosen phases. In addition, the phases and operations described above may be modified. For example, download of a game and game play could be conducted simultaneously. In other words, a subscriber could subscribe to a game and begin downloading the game content and still play a game in response to receipt of a trigger before the download is complete. Additionally, the game server 74 may be programmed to stop receiving game results after a predetermined time in order to ensure that game results are received and winners or top performers can be determined in a reasonable time. In other words, the game server 74 is not required to await receipt of game results from all subscribers. It should also be noted that game results may be measured locally at each mobile terminal. Thus, particularly for timed events, a subscriber who receives the trigger 75 after a delay of any kind will not be handicapped relative to other subscribers. In other words, the game results in one embodiment are locally determined. Alternatively, responses may be provided by a subscriber to a remote game control module, which in turn determines the results. If the game is a timed event, the responses provided by the subscribers may include respective time stamps associated with the commencement of the game at the subscriber's mobile terminal and the entry and/or transmission of the response such that the relevant time may be determined by the game control module without unfair consideration of transmission or other delays not attributable to the subscriber's response.

It should also be noted that there is no need for subscribers to attend the real world event. In other words, for example, a subscriber could subscribe to the game service while watching a sporting event on television. In fact, a subscriber could subscribe to the game service and participate in event triggered games even though the subscriber is not watching the related real world event at all. Accordingly, participation in the event triggered games (particularly if the event triggered games are distinct for each event) may present an interesting way for a fan to monitor a sporting event which the fan cannot attend or watch on television.

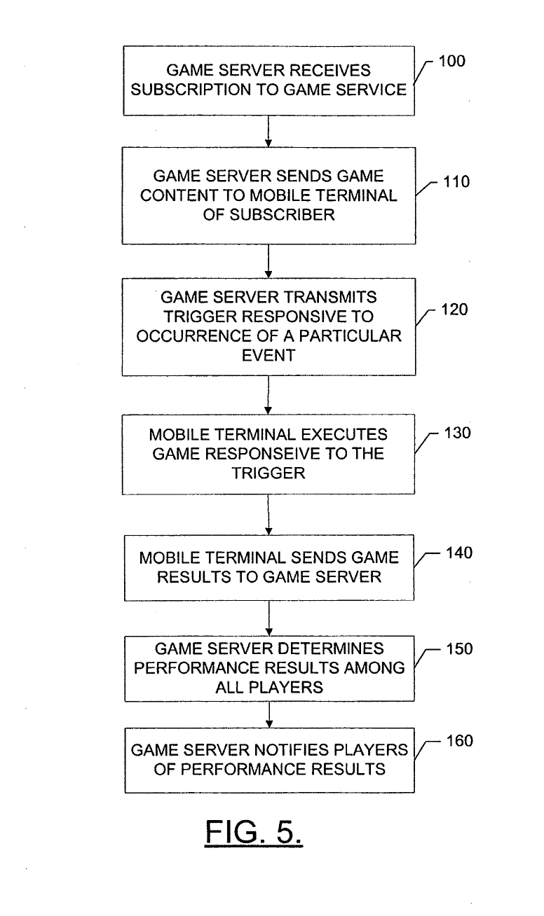

FIG. 5 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal or the game server and executed by a built-in processor in the mobile terminal or the game server. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing event triggered games includes receiving, at a game server, a subscription to a game service from a mobile terminal at operation 100. The subscription may be for any suitable time period. For example, the subscription could be to a short term game service lasting for only for a few hours or for one real world event (i.e., sporting event or other performance). Alternatively, the subscription may be for a long term game service such as for a predetermined period of time (i.e., for an hour, a month, a week, etc.), or a predetermined number of real world events (i.e., for an entire season, or for a specified number of games). At operation 110, the mobile terminal is provided with game content that executes responsive to a trigger initiated remotely from the mobile terminal. The game content is related to the game service. The trigger is issued responsive to an occurrence of a predefined event of interest. At operation 120, the trigger is transmitted to the mobile terminal. The mobile terminal executes the game content responsive to receipt of the trigger at operation 130. At operation 140, the mobile terminal sends game results to the game server. At operation 150, the game server calculates performance results (e.g., a winner or top performers) from among all players or subscribers. At operation 160, the game server notifies the players or subscribers of the performance results. Optionally, an additional operation may involve determining total performance results associated with a plurality of different game results from all players or subscribers. Accordingly, a winner or top performers for a season or at least for multiple real world events covered by a subscription to the game service may be determined.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium. It should also be noted, that although the above described principles have been applied in the context of games related to sporting events, similar principles would also apply to the delivery of games related to other live or recorded events. Moreover, while the forgoing exemplary games have involved multiplayer competition such games could involve a single subscriber working to improve his or her own score or competing against a predefined standard without comparison to other players.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A system for triggering a game related to sporting events, the system comprising:
a game application operating on a mobile phone; and
at least one server having a network connector, wherein the server is connected to the mobile phone over the Internet, the at least one server being configured to:
a) receive a subscription request for a subscription from a subscriber, wherein the subscription is for a predetermined period of time; and
b) transmit a trigger responsive to an event occurring in a team sports game, wherein the trigger is an automatic notification of the event;
wherein the game application (a) automatically executes on the mobile phone in response to receipt of the trigger, and (b) is configured to enable the subscriber to engaged in an interactive activity related to the game.

2. The system of claim 1, wherein the at least one server is connected to a statistical database and is configured to transmit the trigger after one or more real-time statistics are entered into the statistical database.

3. The system of claim 1, wherein the trigger includes game content which modifies a game of the game application.

4. The system of claim 1, wherein the predetermined period of time is a day.

5. The system of claim 1, wherein the predetermined period of time is an hour, a month, or a week.

6. The system of claim 1, wherein the at least one server is further configured to receive game results from mobile phones of a plurality of subscribers.

7. The system of claim 6, wherein the at least one server is further configured to determine game performance results for the plurality of subscribers.

8. The system of claim 7, wherein the at least one server is further configured to notify the plurality of subscribers of the game performance results.

9. The system of claim 1, wherein the at least one server is further configured to determine game performance results for a plurality of subscribers.

10. The system of claim 9, wherein the at least one server is further configured to notify the plurality of subscribers of the game performance results.

11. The system of claim 1, wherein the system is configured to transmit the game application to the mobile phone, wherein the game application is a client of the at least one server.

12. The system of claim 11, wherein the at least one server is further configured to transmit the game application to the mobile phone.

13. The system of claim 1, wherein the trigger is contained in an SMS message.

14. The system of claim 1, wherein the team sports game is a football game, a basketball game, a baseball game, a hockey game or a soccer game.

15. A system for triggering a game related to sporting events, the system comprising:
an application operating on a mobile phone; and
at least one server having a network connector, wherein the server is connected to the mobile phone over a network, the at least one server being configured to:
a) transmit the application to the mobile phone;
b) receive a subscription request for a subscription from the mobile phone, wherein the subscription is for at least one of a short term game service, a long term game service or a predetermined number of real world sporting events; and
c) transmit a trigger responsive to the occurrence of an event in one of a football game, a basketball game, a baseball game, a hockey game or a soccer game, wherein the trigger is an automatic notification of the event;
wherein the application (a) automatically executes in response to receipt of the trigger associated with the event and (b) is configured to enable a subscriber to play the game; and
wherein the at least one server is connected to a statistical database and is configured to transmit the trigger after one or more real-time statistics are entered into the statistical database.

16. The system of claim 15, wherein the trigger includes game content which modifies a game.

17. The system of claim 15, wherein the short term game service is a few hours or for one real world sporting event.

18. The system of claim 15, wherein the long term game service is a predetermined period of time.

19. The system of claim 18, wherein the predetermined period of time is one day.

20. The system of claim 18, wherein the predetermined period of time is an hour, a month, or a week.

21. The system of claim 15, wherein the predetermined number of real world events is a season or a plurality of sports games.

22. The system of claim 15, wherein the at least one server is further configured to receive game results from the mobile phones of a plurality of subscribers.

23. The system of claim 15, wherein the at least one server is further configured to determine game performance results for a plurality of subscribers.

24. The system of claim 23, wherein the at least one server is further configured to notify the plurality of subscribers of the game performance results.

25. The system of claim 15, wherein the network is the Internet.

26. The system of claim 15, wherein the trigger is contained in an SMS message.

27. The system of claim 15, wherein the application is configured to enable a subscriber to engaged in the interactive activity after receipt of the trigger.

28. A system for triggering a game related to sporting events, the system comprising:
an application operating on a mobile phone, wherein the system is configured to transmit the application to the mobile phone; and
at least one server having a network connector, wherein the server is connected to the mobile phone over a network, the at least one server being configured to:
(a) receive a subscription request from a subscriber, wherein a subscription to the game is a single day subscription; and
(b) transmit a trigger related to an event in a team sports game, wherein the trigger is an automatic notification of the event;
wherein the application (a) automatically executes on the mobile phone in response to receipt of the trigger, and (b) is configured to enable the subscriber to engage in an interactive activity after receipt of the trigger.
